(19) United States
(12) Patent Application Publication
(10) Pub. No.: US 2009/0076860 A1
(43) Pub. Date: Mar. 19, 2009

(54) METHOD AND SYSTEM FOR PROVIDING INSURANCE

(75) Inventor: Amnon PELZ, Oranit (IL)

Correspondence Address: BROWDY AND NEIMARK, P.L.L.C.;624 NINTH STREET, NW, SUITE 300, WASHINGTON, DC, 20001-5303, US

(73) Assignee: Taburit - The Central Cord Blood Registry Ltd., Ramat Hasharon (IL)

(21) Appl. No.: 12/182,084

(22) Filed: Jul. 29, 2008

Related U.S. Application Data
(63) Continuation-in-part of application No. 11/340,862, filed on Jan. 27, 2006.
(60) Provisional application No. 60/647,006, filed on Jan. 27, 2005.

(30) Foreign Application Priority Data
Jun. 9, 2005 (IL) 169087

(51) Int. Cl. G06Q 40/00

(52) U.S. Cl. 705/4

(57) ABSTRACT

The invention provides a method for providing insurance. A body material of an animal is deposited in a depository of such animal body material. An insurance policy is established stipulating that the depositor of the animal body material is indemnified for expenses incurred for a medical or cosmetic treatment of the animal requiring body material of the type deposited by the depositor. A periodic premium for the insurance is collected. The invention also provides a system for providing the insurance.

### CROSS-REFERENCE TO RELATED APPLICATION

The present application is a continuation-in-part of application Ser. No. 11/340,862, the entire contents of which are hereby incorporated herein by reference.

### FIELD OF THE INVENTION

This invention relates to methods and systems for providing insurance.

### BACKGROUND OF THE INVENTION

Bone marrow transplantation is used in the treatment of various disorders such as cancer, autoimmune diseases, blood disorders and metabolic disorders. These treatments take advantage of stem cells present in the bone marrow. However, a compatible bone marrow donor can only be found for 40-50% of all cases requiring bone marrow transplantation, and finding a suitable donor can take many weeks, and even months. Umbilical cord-blood also contains stem cells, and has been used as an alternative to bone marrow as a source of stem cells in the treatment of these disorders.

Umbilical blood is newborn blood collected from the umbilical cord after severing of the cord from the newborn. Banks of umbilical cord-blood have been set up in several countries. An individual's cord-blood collected at birth is cryo-preserved for long term storage and deposited in a cord-blood depository or bank. The deposited cord-blood is used should the individual subsequently develop a condition that can be treated by implantation of stem cells derived from his cord-blood. A person whose cord-blood was deposited in a bank at birth can thus be assured of a compatible source of stem cells, and is not dependent upon finding a suitable donor. Furthermore, due to the immaturity of cord-blood derived stem cells, a perfect tissue-typing (HLA) is often not required, in which case cord-blood may be used to treat a sibling of the cord donor. It should also be noted that cord-blood stem cells may be cultured ex-vivo in order to increase the number of stem cells available to the recipient.

U.S. patent application Ser. No. 10/134,055 to Richard, having the publication number US 2003/0014285, discloses a business method in which an insurance company pays the costs of depositing cord-blood in a cord-blood bank for a policy holder of the insurance company. The insurance company may offer this benefit, for example, in order to attract new policy holders. The cost of the deposition may be recouped from the premium of the insurance policy.

It is known to provide insurance to an owner of an animal, such as a domestic animal, a racing or work horse, a hunting dog or racing dog, etc. The insurance may be life insurance policy or a medical treatment policy in which the owner is indemnified for surgical treatment of the animal necessitated by an accident, injury or illness.

### SUMMARY OF THE INVENTION

The present invention provides a system and method for providing insurance to an individual who has deposited a body tissue or organ of an animal in a depository of such organs or tissues. Typically, although not necessarily, the depositor is the owner of the animal. However, the depositor may be a farm, or other enterprise having an interest in the animal.

The animal may be any animal, such as a domestic animal, a farm animal, a racing or work horse, a hunting dog or racing dog, etc. The deposited body tissue or organ may be, for example, umbilical cord-blood or blood from another source, foreskin or other skin, lymph, fetal stem cells, adult stem cells, lymph or sperm.

In accordance with the method of the invention, an insurance policy is established for an individual who deposited a body tissue or organ of an animal in the depository or for a beneficiary of the depositor. In accordance with the invention, as distinct from the prior art, the deposit of the tissue or organ for future use in a treatment of the animal, is a central component of the insurance policy. The insurance policy, in exchange for payment of a periodic premium, indemnifies the policy holder or his beneficiary for at least some of the expenses associated with a medical or cosmetic treatment of the animal that requires body material of the type previously deposited by the depositor in the depository. The medical or cosmetic treatment may either utilize some or all of the animal's tissue or organ that had previously been deposited in the depository, or, substitute body material of the type deposited by the depositor in the depository, in the case that the deposited body material is subsequently found to be not suitable for utilization in the medical or cosmetic treatment of the animal. This would be the case, for example, if the deposited body material had been damaged during storage and could not be used when the animal required it, or if a competent medical person concludes that the deposited material is not suitable for the treatment that the animal requires. The substitute body material may be obtained, for example, from a donor animal that may or may not be related to the animal, or may be a synthetic material that may be used in place of the deposited material.

Expenses associated with the utilization of the deposited material include, for example, medical and laboratory expenses required for implanting at least a portion of the deposited material in the animal's body.

Thus, in its first aspect, the invention provides a method for providing insurance comprising:

obtaining from an animal a body material and depositing the body material in a depository of such body material;

establishing an insurance policy stipulating that the depositor or a beneficiary of the depositor is indemnified for expenses incurred for a medical or cosmetic treatment of the animal requiring body material of the type deposited by the depositor, wherein the medical treatment utilizes either the deposited body material or substitute body material of the type deposited by the depositor; and

collecting a periodic premium for the insurance.

In its second aspect, the invention provides a system for providing insurance comprising a processor having a database of entries, the processor configured to input data indicative of an insurance policy provided by an insurance provider to a depositor of an animal's body material in a depository of body material, and to store the data in an entry of the database, the insurance policy stipulating that the depositor or a beneficiary of the depositor is indemnified for expenses incurred for a medical or cosmetic treatment of the animal utilizing the deposited body material or substitute body material of the type deposited by the depositor.

The invention also provides a computer implemented method for calculating a premium of an insurance policy stipulating that the depositor or a beneficiary of the depositor is indemnified for expenses incurred for a medical or cosmetic treatment of an animal requiring body material of a type deposited by the depositor in a depository of such body material, wherein the medical treatment utilizes either the deposited body material or substitute body material of the type deposited by the depositor, the method comprising calculating a probability that the animal will require a medical or cosmetic treatment requiring body material of a type deposited by the depositor at any time when the policy is valid.

The calculation of the probability may involve one or both of the age of the animal and the state of health of the animal. The calculation of the probability may be based upon other health, disability or life insurance components. The method may further comprise storing in a database data indicative of the insurance policy. The data may, for example, be indicative of an insurance policy provided to a depositor of an animal's body material in a depository of body material and may include the policy holder's name, an identifier of the animal, the date that the deposit was made, information relating to the deposited body material, a serial number or other identifier associated with the deposit, a location of the deposited body material in the depository, and the calculated premium.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a flow-chart for a method for providing insurance in accordance with one embodiment of the invention; and

FIG. 2 shows a system for providing insurance in accordance with one embodiment of the invention.

### DETAILED DESCRIPTION OF THE INVENTION

In the following description, the invention is described in relation to the provision of insurance to a depositor of an animal's umbilical cord-blood in a cord-blood depository. This is by way of example only, it being understood that the invention may be implemented for the provision of any body tissue or organ in a depository of such tissues or organs.

As used herein, the term “depositor” refers to an individual who has deposited a body tissue or organ of an animal in a depository of such tissues or organs. The depositor may be, for example, the owner of the animal.

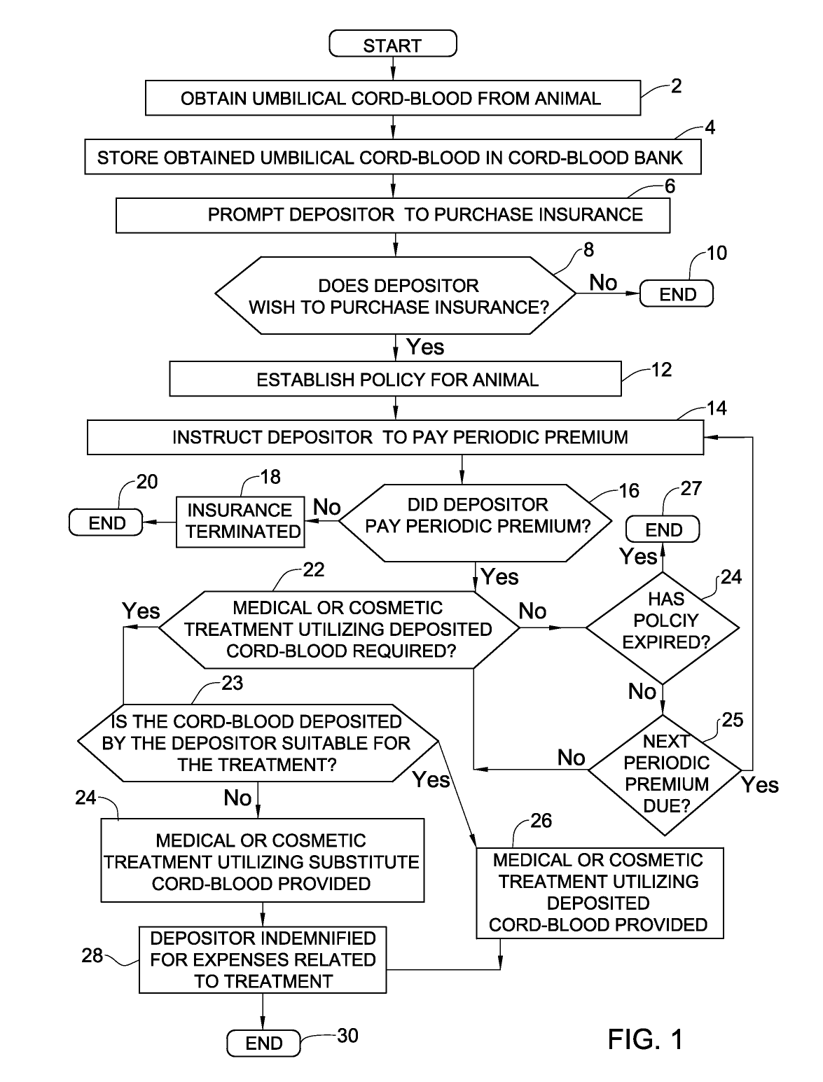

FIG. 1 shows a flow chart for carrying out one embodiment of the method of the invention. In step 2, umbilical cord-blood of an animal is obtained and, in step 4, the obtained cord-blood is deposited in an umbilical cord-blood depository. Details relating to the depositor, the animal and the stored blood are entered into a database.

After the blood has been deposited, in step 6, the depositor, is queried as to whether he wishes to acquire an insurance policy for the animal that indemnifies the depositor for expenses incurred in the case that the animal requires medical or cosmetic treatment that utilizes the deposited blood. In step 8 it is determined whether the depositor wishes to purchase the insurance. If no, the process terminates as step 10. If yes, the process continues to step 12, in which an insurance policy is established for the animal. The depositor is then instructed to pay a periodic premium for the insurance, and in step 16 it is determined whether the depositor has paid the premium. If no, the insurance is terminated (step 18) and the process ends at step 20. If at step 16 it is determined that the depositor did pay the premium, the process proceeds to step 22 where it is determined whether the animal requires medical or cosmetic treatment utilizing the stored cord-blood. If no, it is determined in step 24 whether the policy has expired. If the policy has expired then the process terminates at step 27. If the policy has not expired, it is determined in step 25 whether the next periodic premium is due. If the next periodic premium is due, the process returns to step 14. If the next premium is not due, the process returns to step 22. If at step 22 it is determined that the animal requires medical or cosmetic treatment utilizing the deposited cord-blood, then in step 23 it is determined whether the deposited cord-blood is suitable for the required treatment. If yes, then in step 26 the required medical or cosmetic treatment is provided using the deposited cord-blood. If no, then in step 29 the required medical or cosmetic treatment is provided using substitute cord-blood. After the medical treatment has been provided in either step 26 or step 29, the depositor is indemnified for expenses relating to the provided treatment in accordance with the terms of the insurance policy (step 28), and the process terminates at step 30.

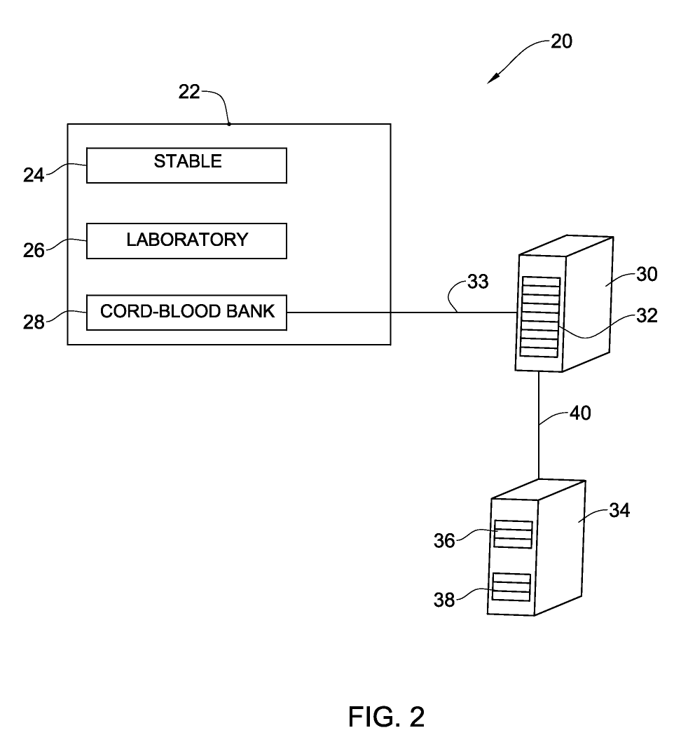

FIG. 2 shows a system 20 in accordance with one embodiment of this aspect of the invention. The system 20 includes a medical installation 22 where umbilical blood is collected, processed and stored. The medical installation may be a distributed installation, in which collection of the blood occurs at one location (e.g. a stable 24), processing the blood occurs at a second location (e.g. a laboratory 26), and storage of the blood is at a remotely located umbilical cord-blood depository 28. The system 20 further includes a first processor 30 having a memory comprising a databank of entries 32. Each entry 32 in the databank includes information relating to a deposit of cord-blood at the blood depository 28 when a cord-blood deposit is made at the cord-blood depository 28. The information is input to the entry from a computer terminal (not shown in FIG. 2) located at the cord-blood depository that communicates with the processor 30 over a communication line 33 that may be a wired or wireless communication line. Details relating to the deposit include, for example, the depositor's name, an identifier of the animal, the date that the deposit was made, the volume of the deposit, any information relating to the blood such as the results of any immunological tests that were performed on the blood. The stored information may also include a serial number or other identifier associated with the deposit, as well as the location of the deposited blood in the blood depository.

The system 20 also includes a second processor 34. The second processor 34 is maintained by an insurance provider and includes a memory comprising a first databank of entries 36 and a second databank of entries 38. The first and second processors communicate with each other over a communication line 40. When a new entry 32 is made in the databank of the first processor, the first processor is configured to communicate at least some of the data in the entry 32 to the second processor of the communication line 40. The second processor is configured to input the data and to store the input data into a new entry in the first database of the second processor. The second processor is further configured to alert the insurance company when a new entry has been made in the first database of the second processor, indicative of a new deposit at the cord-blood depository. This may be done, for example, by the second processor automatically sending an electronic message to a predetermined address informing the recipient of the message of the new cord-blood deposit at the cord-blood depository 28. The message prompts the insurance provider to query the depositor of the deposit as to whether the depositor wishes to acquire from the insurance company an insurance policy that indemnifies the depositor for at least some of the expenses incurred in a medical or cosmetic treatment of his animal utilizing the animal's umbilical cord-blood that was deposited by the depositor in the cord-blood depository. If the depositor elects to acquire an insurance policy from the insurance company, details relating to the acquired policy are stored in a new entry 38 in the second database of the second processor. Each entry of the second database of the second processor thus contains data relating to an insurance policy sold by the insurance company to a depositor of an animal's umbilical cord-blood at the cord-blood depository, where the insurance policy indemnifies the depositor for expenses incurred for a medical or cosmetic treatment of the animal utilizing the deposited umbilical cord-blood.

1. A method for providing insurance comprising:
(a) Obtaining from a depositor a body material of an animal and depositing the body material in a depository of such animal body material,
(b) establishing an insurance policy stipulating that the depositor is indemnified for expenses incurred for a medical or cosmetic treatment of the animal requiring body material of the type deposited by the depositor, wherein the medical treatment utilizes either the deposited body material or substitute body material of the type deposited by the depositor, and
(c) collecting a periodic premium for the insurance.

2. The method according to claim 1, further comprising indemnifying the depositor or beneficiary of the depositor for expenses incurred for a medical treatment of the animal utilizing the deposited body material.

3. The method according to claim 1 wherein the deposited body material is selected from blood, umbilical cord blood, skin, foreskin, lymph, adult stem cells, fetal stem cells and sperm.

4. The method according to claim 1 wherein the animal is a domestic animal, a racing or work horse, a hunting dog or a racing dog.

5. The method according to claim 1 further comprising storing in a database data indicative of the insurance policy.

6. The method according to claim 5 wherein the data indicative of an insurance policy provided to a depositor of body material in a depository of body material is selected from the policy holder's name, the date that the deposit was made, an identifier of the animal, information relating to the deposited body material, a serial number or other identifier associated with the deposit, a location of the deposited body material in the depository.

7. A system for providing insurance comprising a processor having a database of entries, the processor configured to input data indicative of an insurance policy provided by an insurance provider to a depositor of an animal's body material in a depository of body material, and to store the data in an entry of the database, the insurance policy stipulating that the depositor is indemnified for expenses incurred for a medical or cosmetic treatment of the animal utilizing the deposited body material or substitute body material of the type deposited by the depositor.

8. The system according to claim 7 wherein the data indicative of an insurance policy provided to a depositor of body material in a depository of body material is selected from the depositor or policy holder's name, an identifier of the animal, the date that the deposit was made, information relating to the deposited body material, a serial number or other identifier associated with the deposit, a location of the deposited body material in the depository.

9. The system according to claim 7 wherein the processor is further configured to input information relating to a deposit of animal body material in the body material depository and to inform the insurance provider of the deposit.

10. The system according to claim 9 further comprising sending an electronic message to a predetermined address informing the recipient of the message of the deposit made and alerting him to the possibility of acquiring the insurance policy.

11. The system according to any one of claims 7 to 10 wherein the animal body material is selected from blood, umbilical cord blood, skin, foreskin, adult stem cells, fetal stem cells, sperm, and lymph.

12. A computer implemented method for calculating a premium of an insurance policy stipulating that the depositor is indemnified for expenses incurred for a medical or cosmetic treatment of an animal requiring body material of a type deposited by the depositor in a depository of such body material, wherein the medical treatment utilizes either the deposited body material or substitute body material of the type deposited by the depositor, the method comprising calculating a probability that the animal will require a medical or cosmetic treatment requiring body material of a type deposited by the depositor at any time when the policy is valid.

13. The method according to claim 12, wherein the calculation of the probability is involves one or both of the age of the animal and the state of health of the animal.

14. The method of claim 13, wherein the calculation of the probability is based upon other health, disability or life insurance components.

15. The method according to claim 12 wherein the deposited animal body material is selected from blood, umbilical cord blood, skin, foreskin, lymph, adult stem cells, fetal stem cells and sperm.

16. The method according to claim 12 wherein the animal is a domestic animal, a farm animal, a racing or work horse, a hunting dog or a racing dog.

17. The method according to claim 12 further comprising storing in a database data indicative of the insurance policy.

18. The method according to claim 17 wherein the data indicative of an insurance policy provided to a depositor of body material in a depository of body material is selected from the policy holder's name, the date that the deposit was made, an identifier of the animal, information relating to the deposited body material, a serial number or other identifier associated with the deposit, a location of the deposited body material in the depository, and the calculated premium.
